(19) United States
(12) Patent Application Publication
(10) Pub. No.: US 2003/0170371 A1
(43) Pub. Date: Sep. 11, 2003

(54) High fat/fiber composition

(75) Inventors: Patrick A. Jobe, Becker, MN (US); Henry N. Eicher, Minnetonka, MN (US); Pierre P. Frumholtz, Irapuato (MX); Duane O. Rasmussen, Pengilly, MN (US); Phillip L. Fischer, Blaine, MN (US); Jennifer L.G. van de Ligt, Elk River, MN (US)

Correspondence Address: Scott T. Piering, P.O. Box 5624, Minneapolis, MN, 55440-5624, US

(73) Assignee: Cargill, Inc.

(21) Appl. No.: 10/308,870

(22) Filed: Dec. 3, 2002

Related U.S. Application Data
(60) Provisional application No. 60/348,042, filed on Jan. 10, 2002.

(51) Int. Cl. A23K 1/00

(52) U.S. Cl. 426/635

(57) ABSTRACT

The present application is directed to compositions that have a high content of fatty materials and a high fiber content and to methods of producing such compositions. The present compositions may be used to produce high fat content pelleted feeds with improved physical properties such as pellet quality, flowability, oil retention, and durability. The present methods and compositions can provide a “dry” source of fat which can be utilized by mills which lack liquid fat capabilities, and can also provide for the production of pelleted animal feeds with a higher than normal content of added fat.

### CROSS-REFERENCE TO RELATED PATENT APPLICATIONS

The present application claims priority to U.S. provisional application Serial No. 60/348,042, filed on Jan. 10, 2002, which is incorporated by reference herein in its entirety.

### BACKGROUND

Feed pellets generally hold together better when the starches found in the ingredients are cooked with hot water or steam. The starches can gelatinize (like gravy) and bind all the ingredients present (proteins, carbohydrates, fats, etc.) together. The introduction of higher levels of fat in feed formulations can interfere with the ability of starches to gelatinize and cause pellets to fall apart even when cooked.

When extruding or pelleting animal feeds, the introduction of high levels of fat (typically greater than 18%) commonly leads to a decrease in the physical integrity of a pellet. A pellet's integrity can be measured by its pellet durability index (“PDI”) as measured via a procedure similar to that described in Feed Manufacturing Technology III (American Feed Industry Association, Arlington Va. McEllhiney, R. R. (technical Editor), 1985, Appendix G Wafers, Pellets, and Crumbles—Definitions and methods for determining specific weight, durability, and moisture content; Section 6 Durability; Paragraph 2, Pellets and crumbles). Feed pellets desirably have a PDI of at least about 90%. A pellet will lose its ability to stay together as the PDI falls. This is commonly observed when fat content in the material which forms the pellet is increased above 18 wt. %.

Techniques which have been attempted to circumvent this problem include spraying fat onto nutrient formulations after pelleting or extrusion. The additional fat is not incorporated into the feed, but rather coats the feed pellets. This has resulted in feed that is greasy in appearance and touch. Feed sprayed with fat also “clumps” due to the greasy coating. Moreover, many smaller mills are not equipped to spray fats onto pellets or extruded material because the equipment tends to require a large capital investment. Another attempted technique is mixing fat directly in a ribbon blender with the other dry ingredients prior to pelleting or extrusion. This methodology, however, does not improve the pellet durability of the feed material.

### SUMMARY

The present application is directed to compositions that have a high content of fatty materials and a high fiber content and to methods of producing such compositions. The present compositions may be used to produce pelleted feeds with improved physical properties, such as pellet quality, flowability, oil retention, and/or durability. The present methods and compositions also can provide other advantages, including a “dry” source of fat which can be utilized by mills which lack liquid fat spraying capabilities. The present methods and compositions may also allow the production of pelleted animal feeds with a higher than normal content of added fat (e.g., pelleted feeds with fat contents greater than 18 wt. %). The present methods and compositions are typically applicable to all types of feeds with fat inclusion regardless of the intended specie or age of animal. As used herein, “pelleted” refers to material that has been forced through an orifice from either a pellet mill or extrusion process and divided into pellets. The pellets may be dried to facilitate handling and storage of the pellets.

In part, the present application provides high fat/fiber compositions which include a high fiber material and a fatty material. As used herein, a high fiber material refers to a material which contains at least about 50 wt. % “total dietary fiber” or “dietary fiber”, which are understood to be the sum of the soluble and insoluble fibers as determined by AACC Method 32-07. The fatty materials typically include fat but may include or be made up of other lipophilic materials such as fatty acid(s), diglycerides, monoglycerides, phospholipids and/or salts of such materials. As used herein, the term “fat” refers to materials made up of one or more triesters of glycerol (“triglycerides”) and typically includes triacylglycerols derived from animal and/or plant sources. Non-exhaustive examples of suitable fats from plant sources include vegetable oils such as soybean oil, sunflower oil, corn oil, flaxseed oil, safflower oil, palm oil, and mixtures thereof. Non-exhaustive examples of suitable fats from animal sources include tallow, poultry fat, pork fat, beef fat, fish oil, and mixtures thereof. The fatty material may also include amounts of other lipid soluble nutrients, such as lipid soluble vitamins and oil processing products such as soy lecithin and soapstock. Where desired, the fat or other fatty material may be selected to contain specified amounts of certain fatty acid residues, such as conjugated fatty acid(s) (e.g., conjugated linoleic acid) and/or omega-3 fatty acid(s).

One embodiment of the present application provides a high fat/fiber composition which includes at least about 30 wt. % plant fiber, such as cotyledon fiber, hull fiber, bran fiber, root vegetable fiber or combinations thereof. Other examples of fiber include oat hull fiber, beet pulp, sunflower hull fiber, corn hull fiber, soy hull fiber and/or soy cotyledon fiber. The high fat/fiber composition desirably includes at least about 20 wt. % fatty material. All weight percents described herein are based upon a dry solids basis (dsb) and all moisture weight percents are on a total composition basis unless stated otherwise. The fatty material may be derived from vegetable or animal sources. More desirably, the composition includes at least about 20 wt. % fat and in a particularly desirable embodiment includes at least about 30 wt. % fatty material. The fatty material may include polyunsaturated fatty material, and in one embodiment may include at least about 25 wt. % polyunsaturated fatty material. Variations of the composition may have a plant fiber content of about 40 wt. % or higher as the high fiber source. For example, the high fat/fiber composition may include at least about 30 wt. % fat and at least about 40 wt. % plant fiber. The high fat/fiber composition is advantageously dried to a moisture content of no more than about 10 wt. % on a total composition basis and, more preferably, no more than about 7 wt. % to enhance its flowability, storage, and handling properties. The high fat/fiber composition generally includes no more than about 10 wt. % proteinaceous material.

In part, the present application also provides a flowable particulate high fat/fiber material that includes at least about 30 wt. % of a fiber material derived from oilseed material and at least about 30 wt. % fatty material. Generally, the fiber material may include about 50 to 70 wt. % insoluble non-starch polysaccharides and about 15 to 30 wt. % soluble non-starch polysaccharides. An example of a suitable fiber material may include defatted, protein depleted soy cotyledon material, which commonly includes at least about 75 wt. % total fiber, no more than about 10 wt. % proteinaceous material, and no more than about 2 wt. % fat. In a desirable embodiment, the high fat/fiber material includes at least about 40 wt. % of fiber material derived from defatted, protein depleted soy cotyledon material. Other non-limiting examples of suitable plant fiber materials may include hull fiber material such as oat hull fiber, sunflower hull fiber, and soybean hull fiber, root vegetable fiber such as beet pulp, malt sprouts, grain screenings, and bran fiber (e.g., defatted rice bran, corn bran, wheat bran). Preferably, the high fat/fiber material includes no more than about 10 wt. % proteinaceous material.

The terms “flowable”, “freely flowable”, and “flowability” as used herein are meant to describe a flow characteristic of particulate materials, such as a powder or granular material. A flowable particulate material flows freely through a conduit without the aid of additional flow enhancing steps such as fluidizing. The flowability of a particulate material, such as a powder, can be measured by determining the angle which is required for the material to flow (angle of repose).

In part, the flowable particulate material can include at least about 30 wt. % fatty material, at least about 30 wt. % fiber material, and no more than about 10 wt. % protein. The fiber material is preferably a plant fiber material, and may include cotyledon fiber (e.g., soy cotyledon fiber), hull fiber (e.g., oat hull fiber, sunflower hull fiber, soy hull fiber, corn hull fiber, rice hull fiber), bran fiber (e.g., rice bran, corn bran, wheat bran), and/or root vegetable fiber (e.g., beet pulp and maltsprouts). The fiber material may also include processed cellulose and hemicellulose. The fiber material may include about 50 to 70 wt. % insoluble polysaccharides and about 15 to 30 wt. % soluble non-starch polysaccharides. The fatty material may be derived from animal or plant sources. Other embodiments of flowable particulate material may contain varying levels of fiber material and fatty material, including one embodiment having at least about 50 wt. % fatty material and at least about 45 wt. % fiber material. Other embodiments may include at least about 40 wt. % fiber material. The flowable particulate material desirably has no more than about 7 wt. % water on a total composition basis. The flowable particulate material may be added to an animal feed premix to provide an animal feed with increased levels of fat.

The fatty material is believed to be incorporated within the fiber material to provide a dry flowable particulate material. As a result, the fatty material will typically not be easily released by the dry flowable particulate material, which can be in powder or granular form, and enhance flowability of the material. Desirably, the flowable particulate material flows at an angle of repose of no more than about 35 degrees, and even more desirably at an angle of repose of no more than about 33 degrees.

Yet another embodiment of the present application provides a high fat/fiber composition which includes at least about 30 wt. % fiber and at least about 15 wt. % and, more preferably, at least about 25 wt. % (on a total composition basis) of solids material derived from fish solubles. Such composition can be produced according to the present methods to provide a composition in which the oil is substantially incorporated into the fiber. “Fish solubles” refers to a waste product of fish processing that is an aqueous dispersion and/or emulsion which commonly includes about 5-10 wt. % fat and about 30-35 wt. % protein. The fiber material is desirably a substantially insoluble polysaccharide material, such as the fiber in oilseed cotyledon material or hull fiber material. One suitable example of this type of material is a defatted, protein-depleted soybean cotyledon material.

A method of making a high fat/fiber composition is also provided. The method includes forming an emulsion including fatty material and an aqueous solution, such as water, and contacting the emulsion with high plant fiber material to provide a mash. The emulsion desirably is a liquid-liquid system with a temperature sufficient to maintain the fatty material in a liquid state. The emulsion preferably has a temperature of greater than about 70° F., with a temperature of at least about 120° F. more preferable, and even more preferably a temperature of at least about 150° F. The temperature of the emulsion will not generally exceed 200° F. at atmospheric pressure to maintain the emulsion as a liquid. The mash may be heated as well. In one embodiment, approximately twice the amount of emulsion may be contacted with the high fiber material to make the high fat/fiber material, although other ratios of emulsion to high fiber material may be used. Generally, a desired fat to fiber ratio is one to one. In particular embodiments, the emulsion may contain 30 to 80% fatty material in relation to water, and may also include an emulsifying agent. Examples of emulsifying agents include lecithin, alginate, carrageenan, glycol, a fatty acid salt, other non-ionic surfactants or a combination thereof. The emulsion may be formed, in part, through the use of either a dynamic mixer (e.g., a mixer that mixes with the assistance of mechanical action by one or more moving parts driven by an external power source) or a passive mixer (e.g., using the inherent energy of one or more flowing fluids to provide mixing action). Preferably, but not necessarily, equal parts of fatty material and water may be contacted to provide the emulsion.

In a desired embodiment, the mash may be dried to provide a high fat/fiber material with a water content of no more than about 10 wt. % on a total composition basis. The mash may be dried whole in the form of relatively large solid pieces, or may be comminuted (such as via grinding) into smaller particles, e.g., granular or powdered forms, to provide a flowable high fat/fiber material. The flowable high fat/fiber material preferably has an angle of repose of no more than about 35 degrees, with an angle of repose of no more than about 33 degrees even more preferred.

The present application also provides a method of making a high fat/fiber composition by providing a wet fiber mixture that includes high fiber material and at least about 30 wt. % water on a total composition basis, and adding fatty material to the fiber mixture to form a fat/fiber mixture. The fat/fiber mixture may be agitated by such methods as stirring, mixing, and blending. Desirably, the fatty material is in a liquid state. The fatty material is preferably included in an emulsion that includes fatty material, water, and, optionally, an emulsifying agent. The emulsion may have a temperature of at least about 70° F., and more preferably at least about 120° F. The fatty material may include at least about 25 wt. % polyunsaturated fatty material. The high fiber material may include plant fibers as described herein, including cotyledon fiber, hull fiber, root vegetable fiber, processed cellulose or hemicellulose, and/or bran fiber. Generally, the high fiber material has no more than about 10 wt. % protein and may be present in amount of at least about 30 wt. % the wet fiber mixture. In alternative embodiments, the water content may be at least about 50 wt. % on a total composition basis. The water can be removed from the fat/fiber mixture to provide a high fat/fiber composition that desirably includes at least about 30 wt. % high fiber material and at least about 30 wt. % fatty material, all calculated on a total composition basis. The water is most commonly removed by drying with or without the addition of heat to a final level of no more than about 10 wt. %.

In part, provided is a method of making an animal feed by adding the mash or fat/fiber mixture to an animal feed premix to provide an animal feed blend. The animal feed premix may be a variety of dry and/or wet ingredients used to make animal feed. The animal feed blend may be further processed into pelleted form by forcing the high fat animal feed blend through an orifice and dividing the animal feed into pellets. This may be done, for example, by either en extrusion process or a pelletizing process. The animal feed pellets may then be dried to a moisture content of no more than about 10 wt. % on a total composition basis.

The animal feed may also be made by providing an animal feed premix and adding an emulsion to the animal feed premix to provide an animal feed blend. The emulsion includes water and fatty material. Generally, the emulsion has a temperature of at least about 70° F., with a temperature of at least about 120° F. being more preferable, and more desirably at least about 150° F. The fatty material may include polyunsaturated fatty material, and, preferably, the fatty material includes at least 25 wt. % polyunsaturated fatty material. The animal premix includes fiber, such as plant fiber. Suitable fibers may include 50 to 70 wt. % insoluble non-starch polysaccharides and about 15 to 30 wt. % soluble non-starch polysaccharides. Other examples of suitable fiber may include cotyledon fiber, hull fiber, bran fiber, and/or processed cellulose/hemicellulose. The animal feed premix and resulting blend desirably includes at least about 2 wt. % fiber, with a fiber content of at least 5 wt. % preferred. The animal feed blend desirably includes at least about 18 wt. % fatty material, with at least about 20 wt. % preferred. Additionally, it may be desired to heat the high fat animal feed blend to facilitate adsorption/absorption of fatty material into the fat-depleted fiber and prepare the animal feed for additional processing.

The high fat animal feed blend may be further processed into pellet form by forcing the animal feed blend through an orifice and dividing the animal feed blend into segments. This may be done by either en extrusion process or a pelletizing process. The animal feed blend segments may then be dried to provide a pelleted animal feed with no more than about 10 wt. % water on a total composition basis. The pelleted animal feed desirably has a dry surface texture, and is relatively non-sticky to prohibit excessive clumping of the feed. The pelletized animal feed desirably has a pellet durability index (PDI) of at least about 90%. The PDI may be determined using a procedure adapted from: McEllhiney, R. R. ((technical Editor). 1985. Appendix G Wafers, Pellets, and Crumbles—Definitions and methods for determining specific weight, durability, and moisture content; Section 6 Durability; Paragraph 2, Pellets and crumbles. In Feed Manufacturing Technology III. American Feed Industry Association, Arlington Va.), the disclosure of which is herein incorporated by reference. The procedure includes the following steps:

1) Obtain a composite product sample by obtaining several samples at regular intervals throughout production. The samples should be mixed together for testing.

2) Screen sample with the appropriate screen as set forth on the Screen Sizes for Pellet and Crumbles Durability Tests (Table 1), by shaking it 30 times.

3) Place a 500-gram sample (±10 grams) in a tumbler compartment. An exemplary tumbler may be 25×12.5×12, including four chambers and tumble at about 54 rpm.

4) Tumble sample for 10 minutes.

5) Screen sample with the appropriate screen as set forth on the Screen Sizes for Pellet and Crumbles Durability Tests by shaking it approximately 30 times.

6) Document the amount of sample and the amount of screened product.

TABLE 1
SCREEN SIZES FOR PELLET AND
CRUMBLES DURABILITY TESTS

| Size | | Required Screen Size | |
|---|---|---|---|
| Pellets or Crumbles | | | Decimal Equiv., |
| Fraction, in. | Decimal Equiv., in. | Size | in. |
| | All Crumbles . . . | No. 12 | 0.0661 |
| Pellets | | | |
| 3/32 | 0.0938 | No. 10 | 0.0787 |
| ⅛ | 0.1250 | No. 7 | 0.1110 |
| 9/64 | 0.1406 | No. 6 | 0.1320 |
| 5/32 | 0.1563 | No. 6 | 0.1320 |
| 3/16 | 0.1875 | No. 5 | 0.1570 |
| 13/64 | 0.2031 | No. 4 | 0.1870 |
| ¼ | 0.2500 | No. 3 ½ | 0.2230 |
| 5/16 | 0.3125 | 0.263 | 0.2650 |
| ⅜ | 0.3750 | 5/16 | 0.3125 |
| ½ | 0.5000 | 7/16 | 0.4375 |
| ⅝ | 0.6250 | 0.530 | 0.5300 |
| ¾ | 0.7500 | ⅝ | 0.6250 |
| ⅞ | 0.8750 | ¾ | 0.7500 |
| 1 | 1.000 | ⅞ | 0.8750 |

* American Society for Testing and Materials, ASTM E 11-61, Specifications for Wirecloth Sieves for Testing purposes

Alternatively, the pelleted animal feed may have a pellet breaking index of at least about 50%. As used herein, “pellet breaking index” refers to an alternative test to PDI as determined by the following test. A pellet sample is weighed between 2 to 50 grams after removing fines with the U.S. #8 Sieve. The sample is then placed into a feeder funnel, such as a Fritch Variable Speed Feeder funnel. The feeder rate is set at 6.5 and the feeder is turned on. The Fritch Variable Speed Feeder should be set to start at the same time as a cyclone, such as a Wisconsin Breakage Tester. The sample may be recovered at the exit of the cyclone and screened using the U.S. #8 Sieve, discarding the fines. The weight of pellets and pieces remaining on the #8 Sieve are recorded and the test is repeated with a second sample. The surviving sample weight is divided by the starting sample weight, which will provide a breakage index for each sample.

The methods and high fat/fiber compositions described herein allow the production of pelleted animal feeds with excellent durability despite a higher than normal content of added fat (e.g., pellet feeds with fat contents greater than about 18 wt. % dsb). In particular, the present application provides an animal feed which includes at least about 18 wt. % fatty material and at least about 5 wt. % plant fiber material. The animal feed preferably has a pellet breaking index of at least about 50% and/or a pellet durability index of at least about 90%. Desirably, the plant fiber material includes at least about 5 wt. % plant fiber, which may include cotyledon fiber, hull fiber, bran fiber and/or root vegetable fiber. A preferred embodiment includes at least about 20 wt. % fatty material and at least about 5 wt. % soy cotyledon fiber. The animal feed may also include at least about 1 wt. % of polyunsaturated fatty material derived from the fatty material, and preferably includes at least about 2 wt. % polyunsaturated fatty material, and even more preferably includes at least about 5 wt. % polyunsaturated fatty material.

In an exemplary embodiment, the pelletized animal feed includes at lest about 5 wt. % plant fiber and at least about 2 wt. % added fatty material. As used herein, “added fatty material” refers to fatty material not inherently present in the ingredients used to make the animal feed premix. The animal feed has an oil release factor of no more than about 40%, and more preferably no more than about 35%. The “oil release factor” is a measurement of fatty material bound to the animal feed, and is measured by the procedure described herein. The animal feed is also durable with a pellet breaking index of at least about 50% and/or a pellet durability index of at least about 90%.

It is to be understood that both the foregoing summary of the invention and the following description of the drawings and detailed description are of a preferred embodiment, and not restrictive of the invention or other alternate embodiments of the invention.

### DESCRIPTION OF THE FIGURES

FIG. 1 is a schematic of an apparatus used to measure the angle of repose having a handle, speed square and a base.

FIG. 2 is a schematic of a process for making a feed in accordance with the teachings of the present application.

FIG. 3 is a schematic of a an alternative process for making a feed in accordance with the teachings of the present application.

### DETAILED DESCRIPTION

The preferred embodiment of a high fat/fiber material includes a fiber material and fatty material. A suitable fiber material may be a high fiber material. Fiber sources differ in the amount of soluble and insoluble fiber they contain. As used herein, “soluble” and “insoluble” dietary fiber is determined using American Association of Cereal Chemists (AACC) Method 32-07. As used herein, an “insoluble” dietary fiber source is a fiber source in which at least 60% of the total dietary fiber is insoluble dietary fiber as determined by AACC Method 32-07. Generally, the fiber material may include 50 to 70 wt. % insoluble non-starch polysaccharides and about 15 to 30 wt. % soluble non-starch polysaccharides.

In one particularly desirable high fiber containing material, cellulosic insoluble non-starch polysaccharides make up no more than about 30 wt. % of the insoluble non-starch polysaccharides. The fiber material may be derived from an oilseed material or other source of plant fiber, such as a defatted and/or protein-depleted soybean material. Fiber materials derived from oilseed cotyledons, e.g., fiber materials derived from soybean cotyledons, are particularly suitable for use in the present compositions. The cotyledon material is preferably at least partially defatted and protein depleted such as soy cotyledon material commercially available under the name POLYSOY (Protein Technologies International of St. Louis, Mo.), which includes soy cotyledon fiber that is representative of the insoluble dietary fibers. Oilseed cotyledons having a fiber content of at least about 30 wt. % and, more desirably, at least about 50 wt. %, and even more desirably at least about 75 wt. % are quite suitable for use in the present compositions. Preferably, the fiber containing material has a fiber content of at least about 85 wt. %. Such materials typically have a protein content of no more than about 10 wt. %. Commercially available dried soy cotyledon material (i.e., having a moisture content of no more than about 10 wt. %) commonly includes at least about 75 wt. % total fiber, about 10-20 wt. % protein, and typically no more than about 1-2 wt. % fat (each stated on a dry solids basis; “dsb”). Other embodiments may utilize other types of fiber containing material including hull material (e.g., oat hull material, sunflower hull material, corn hull, flaxseed hull, rice hull material and soybean hull material), root vegetable material (e.g., beet pulp and maltsprouts), and low fat bran material (e.g., defatted rice bran, corn bran, and wheat bran). Grain screenings may also be used, which are obtained in the cleaning of grains which are included in the United States Grain Standard Act and other agricultural seeds. Grain screenings may include light and broken grains and agricultural seeds, hulls, chaff, joints, straw, elevator dust, sand and dirt.

Soy fiber is, for the most part, an insoluble mixture of cellulosic and non-cellulosic structural components of the internal cell wall. The major fractions of soy cotyledon fiber are non-cellulosic and consist of acidic polysaccharides, arabino-galactan and arabinan chains. Soy cotyledon fiber generally includes only roughly 10-15% cellulosic components. In particular, such fiber can be derived from dehulled and defatted soybean cotyledon and are typically comprised of a mixture of cellulosic and non-cellulosic internal cell-wall structural components. Acidic polysaccharides are highly branched polymers commonly made of a backbone of D-galacturonic acid and D-galactose interspersed with L-rhamnose. Soy hull fiber commonly includes higher levels of cellulosic fiber (circa 45-55 wt. %). The major non-cellulosic components of soy hull fiber are galactomannans, xylan, and acidic polysaccharides. Soy cotyledon fiber is generally bland-tasting, contains very little cholesterol, and is low in fat and sodium. Soy cotyledon fiber generally has excellent water-binding properties. Soy cotyledon fiber material with a high fiber content may be produced from soybean flakes by defatting with a solvent such as hexane and subsequently extracting protein from the defatted flakes with a basic solution. Although cotyledon fiber is preferred, other fiber sources, including hull fibers material, may also be utilized by the present methods.

The fatty materials typically used with the present compositions include fat from animal and plant sources or other lipophilic materials such as fatty acid(s), diglycerides, monoglycerides, phospholipids, and/or salts of such materials. The fatty material may also include amounts of other lipid soluble nutrients, such as lipid soluble vitamins, lecithin, and soapstock. Where desired, the fatty material may be selected to contain specified amounts of certain fatty acid residues, such as conjugated fatty acid(s) (e.g., conjugated linoleic acid) and/or omega-3 fatty acid(s), for example from fish solubles. In particular embodiments, the fatty material may include polyunsaturated fatty materials, with some fatty materials having at least about 25 wt. % polyunsaturated fatty materials.

The high fat/fiber material may include varying levels of fiber material and fatty material. Preferably, the high fat/fiber material includes at least about 30 wt. % fiber material and at least about 20 wt. % fatty material on a total composition basis. Other embodiments may have fiber material of at least about 40 wt. % or at least about 55 wt. %. Similarly, the content of fatty material may vary and some embodiments may include at least about 30 wt. % fatty material or at least 50 wt. % fatty material. The fatty material may also be present in the form of fat, with high fat/fiber compositions having at least about 20 wt. % fat. The fiber material is desirably derived from soy cotyledons and preferably is at least partially defatted and protein-depleted, although other fiber materials may be used.

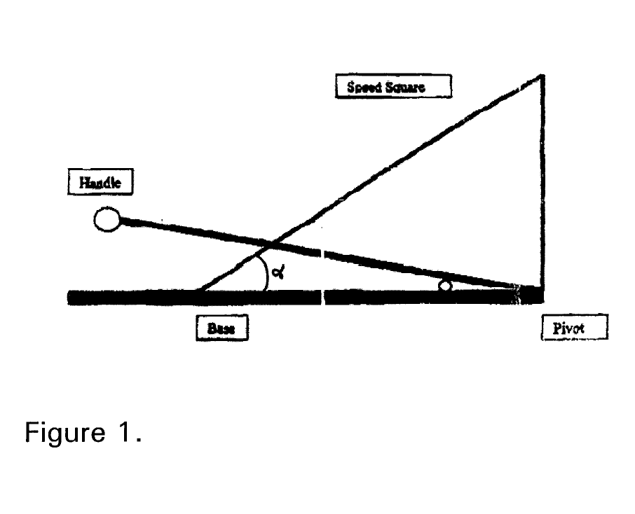

In the preferred embodiment, the high fat/fiber composition may be either moisturized or dried to a moisture content of no more than about 10 wt. % on a total composition basis for storage and handling. When dried, the high fat/fiber composition may be in granular form to provide a flowable high fat/fiber composition. The flowable material generally has an angle of repose of no more than 35 degrees as determined by the apparatus shown in FIG. 1. The apparatus is generally a speed square attached to a base. A metal plate is attached to the base by a hinge, and may be raised and lowered between 0 and 90 degrees. In the preferred apparatus, the metal plate is a 6″×7″, 16 gauge steel plate with a milled finished surface. The high fat/fiber composition may be placed upon the plate and as the plate is raised, the angle may be recorded where the high fat/fiber composition slides down the plate. Preferably, the angle of repose is no more than about 33 degrees.

In part, the high fat/fiber composition is flowable because the fatty material is believed to be incorporated within the fiber material and, as a result, has a low oil release factor. As used herein, “oil release factor” is a measurement determined by the following Soxhlet extraction experimental procedure using untreated and pet ether soaked pretreated samples. Ankom bags (or other suitable sample containers such as soxhlet thimbles) are dried at 105° C. for at least 3 hr, cooled in a dessicator, weighed, and recorded. About 0.5 g of untreated, ground sample (e.g., high fat/fiber composition or animal feed) is added to the dried Ankom bags. The untreated, ground sample is analyzed for dry matter content. In addition, each of the untreated and unground samples also undergoes a room temperature pet ether soak pretreatment in which 1) approximately a 10 g sample is added to about 30 ml pet ether, 2) the material is soaked for 5 minutes; 3) the ether soaked material is filtered through filter paper to collect the residue (15 more mls of pet ether should be used to rinse the samples from the soaking vessel); and 4) the filter paper plus residue is placed in a functioning hood overnight. The following day, the room temperature pet ether pretreated samples is ground and about 0.5 g of each pretreated, ground sample is placed in the remaining dried and preweighed Ankom bags. The pretreated, ground samples are also analyzed for dry matter. Next, a 3 hour pet ether soxhlet extraction is performed on both the untreated, ground and pretreated, ground samples contained within the Ankom bags. The soxhlet extracted samples are placed in a hood for a minimum of 1 hour to evaporate residual pet ether and then placed in a 105° C. oven late in the afternoon and dried overnight. After drying, the dried samples are transferred in the Ankom bags to a dessicator for cooling. After cooling, the weight of each cooled soxhlet extracted sample and bag is recorded. Percentage fat is calculated on a dry solids basis (dsb) as the difference between the ‘dsb’ beginning weight (e.g. approximately 0.5 g corrected to dsb) and the ‘dsb’ final soxhlet extracted residue weight (e.g. final cooled soxhlet extracted sample and bag weight minus the original dsb bag weight) divided by the ‘dsb’ beginning weight. The oil release factor is then be calculated as the difference between the percentage of fat in the untreated sample and the percentage of fat in the pretreated sample divided by the percentage of fat in the untreated sample. The fatty material is believed to be bound to or within the fiber material to provide the “dry” feel, unlike fatty material which has been sprayed onto the surface of materials, which can cause clumping of the material and impart a moist look and feel. The high fat/fiber composition may be used as an additive in animal feeds to increase the availability of fat and fiber.

The high fat/fiber composition may be made by forming an emulsion that includes fatty material and water, and contacting the emulsion with a high fiber material to provide a mash. The emulsion can be produced by contacting the fatty material with water and agitating the fatty material-water solution for a sufficient time to produce an emulsion. The fatty material may include fat(s) and/or other oil(s) readily available for introduction in feed. The emulsion is a liquid-liquid system, having a temperature to maintain the fatty material in liquid state. Typically, a room temperature emulsion (at least about 70° F.) is sufficient, although a temperature of at least about 120° F., and more desirably at least about 150° F. is more preferable. The mash may be agitated for a sufficient time (by stirring, mixing, blending, or other known methods) to permit the high fiber material to incorporate the emulsion within the high fiber material, or adsorb the emulsion in a manner that prevents the fatty material from readily releasing from the fiber material. The advantageous effects of this method on producing a composition with a low oil release factor is shown in Table 2, which compares the oil release factors of animal feed blends with sprayed fat and animal feed blends with the flowable high fat/fiber material (FP). The animal feed blends are more fully described in Example 3, Table 3.

TABLE 2

| Sample | | | Avg. | Oil Release |
|---|---|---|---|---|
| # | Description | Pre-treatment | % Fat | Factor |
| 3a | Neg Control | none | 5.5% | |
| 3a | | Ether soak | 4.1% | 25.5% |
| 3b | 2.5% PF | none | 6.4% | |
| 3b | | Ether soak | 3.6% | 43.8% |
| 3c | 5.0% PF | none | 9.0% | |
| 3c | | Ether soak | 4.9% | 45.6% |
| 3d | 5.0% FP | none | 8.0% | |
| 3d | | Ether soak | 6.1% | 23.8% |
| 3f | 10.0% FP | none | 8.0% | |
| 3f | | Ether soak | 5.1% | 36.3% |
| 3g | 15.0% FP | none | 12.0% | |
| 3g | | Either soak | 7.5% | 37.5% |

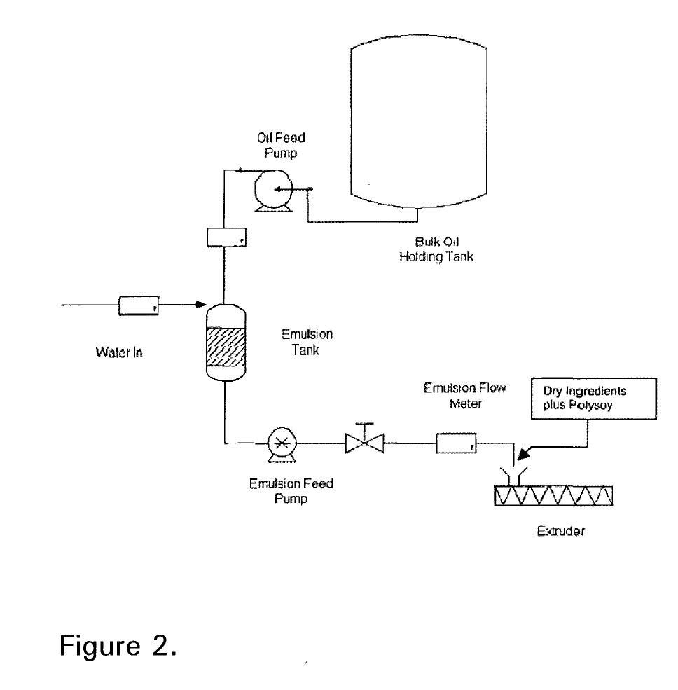

The emulsion may be prepared using a dynamic mixer as shown in FIG. 2. As used herein, “dynamic mixers” have one or more moving parts driven by an external power source such as a motor that promotes mixing by providing energy to the flow of incoming streams resulting in “dynamic mixing.” Examples of dynamic mixers include stirred tank reactors, blenders, shakers, homogenizers, and in-line mixers. An example of a dynamic mixer commonly employed is a high shear, in-line mixer available from Controls and Meters, Minneapolis, Minn.

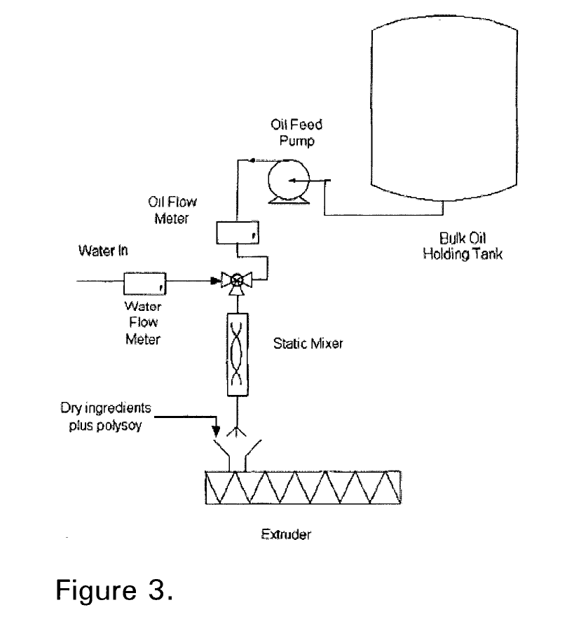

In an exemplary embodiment, a passive, non-dynamic mixer may be used to provide the emulsion as shown in FIG. 3, and in many cases, may be more desirable based upon their size and energy requirements. A passive mixer is different from a dynamic mixer in that it is free of internally moving parts driven by, for example, a motor. Rather, passive mixing uses the inherent energy of flow from one or more fluid streams coming into the mixer to provide the mixing action (a/k/a “passive mixing”). Without the need for a motor and many mechanical parts to effect the mixing action, passive mixers are generally small mixers that do not take up very much space or utilize very much energy. The fluid streams generally flow into the passive mixer by a pump, although other means of flow may be utilized including gravity flow. The pumps may be separate from the passive mixer. Unexpectedly, the fatty material and water form an emulsion upon being agitated within the mixer despite the passive nature of the mixing action. Examples of passive mixers include venturi mixers, orifice-type homogenizers, and static mixing devices. A static mixer that may be used includes model 500-12, ½ inch diameter by 6 inch length (12 elements), 304 SS, manufactured by Komax, although the specification may vary depending on flow characteristics including velocity, flow rate, specific gravity, viscosity and diameter of piping. Static mixers can deliver numerous advantages including low capital costs, low pressure drops, low energy consumption, low space requirements, and no moving parts. Another advantage for the static mixer is the absence of seals. Nevertheless, the advantages of static mixers and other passive mixing devices apparently have not been appreciated for feed processing as disclosed herein.

A static mixer can comprise a series of stationary mixing elements inserted end-to-end along the direction of flow in a pipe, channel, sump, duct, or other housing where the streams to be mixed are flowing together. Each of the mixing elements can be a specially designed rigid structure which divides and recombines the flow stream. Mixing can be achieved as the redirected fluid follows the geometry of the flow channels of the static mixing elements. As more mixing elements are used in the static mixer, the fluid discharge from the mixer becomes more homogeneous. Multiple static mixers can be used as needed, including series and parallel arrangements of static mixers.

Preferably, the static mixer is a long, cylindrical pipe containing a number of helical elements. The length of the static mixer can be varied to achieve the desired performance. Length can also depend in part on the scale of the operation. Typical lengths in a pilot-plant production scale include about 6 inches, but may be about 3 inches to 36 inches. The static mixer may also include multiple mixing elements, with 2 to 14 mixing elements being common. Typical mixing elements are fixed into the housing of the static mixer and include screw-shaped elements. Examples of static mixers which can be used include those available from Komax, Kenics, North Andover, Mass., and Statomix, Salem, N.H. A preferred static mixer is a 6 inch static mixer having a diameter of 0.5 inches and 12 screw shaped elements.

The specific design of the static mixer best suited for providing the emulsion or combining the emulsion to other incoming streams can depend on factors known in the art including the flow regime (laminar or turbulent), the presence of solids and/or gases, and the relative flow rates, concentrations, viscosities, densities of the streams, temperature, and pressure. One skilled in the art can adapt the selection of the static mixer, or other passive mixing device, to the particular conditions desired.

An emulsifying agent may be added to the fatty material-water solution to facilitate formation of the emulsion. Examples of suitable emulsifying agents include lecithin, alginates, carrageenans, glycols, other nonionic surfactants or combinations thereof. Specific non-exhaustive examples of suitable emulsifying agents include soy lecithin, alkali alginate, and fatty acid salt (e.g., sodium salts of soybean fatty acids). Sodium alginate is a particularly suitable emulsifying agent for use in producing the emulsions used to form the present compositions. For example, sodium alginate may be added to fatty material-water solution heated to about 150° F. for about 5 to 10 minutes in a dynamic mixer to facilitate forming the emulsion. In one embodiment, the emulsion may be heated to a temperature of at least about 120° F. and, more desirably about 170° F. (circa 76° C.) to 180° F. (circa 82° C.). Alternatively, the aqueous solution and/or fatty material may be heated prior to contacting one another to form the emulsion. The emulsion may be heated by a variety of methods known to those skilled in the art including steam-jacketed tanks, piping, steam injection, and other means of heat conduction or direct heating. Commonly, approximately equal amounts of fatty material and water may be combined to form the emulsion, but this is not a necessary requirement.

The high fiber material and emulsion can be contacted and may be agitated for a sufficient period of time, typically about 10 to 100 minutes, to form the mash. In the preferred embodiment, the high fiber material may be mixed with approximately twice the amount of emulsion to provide the mash. The high fiber material desirably incorporates (e.g., by absorption and/or adsorption) essentially all of the emulsion. The mash may require additional heating to remain at a suitable temperature for incorporating the emulsion or for additional processing.

The mash can be further processed to a flowable high fat/fiber composition by extruding or pelletizing the mash. For example, the mash may be forced through an orifice and divided to provide pellets. The mash may be divided by a rotating die, knife, or other method known to those skilled in the art. The pelleted high fat/fiber composition may be dried to form a high fat/fiber material that is typically dry to the touch, without having a greasy look or feel. The emulsion is believed to be incorporated within the fiber, resulting in a lower oil release factor than a mash formed without an emulsion. The dried high fat/fiber preferably has a water content of less than about 10 wt. %, and more preferably less than about 7 wt. % on a total composition basis. The dried high fat/fiber composition is generally flowable at this stage, but if desired, the dried composition can be further comminuted (e.g. via grinding) to form a flowable high fat/fiber particulate material that has an angle of repose of no more than about 35 degrees, with an angle of repose of no more than about 33 degrees preferred. The preferred dried high fat/fiber material includes about 40 to 50 wt. % fiber material and about 40-50 wt. % fatty material. The dried high fat/fiber material may be added to other compositions as an additive (e.g., feed compositions) or packaged for commercial sale.

In an alternative embodiment, the high fat/fiber composition may be made by providing a fiber mixture that includes plant fiber material and water, and adding fatty material to the fiber mixture to form a fat/fiber mixture. Generally, the fiber mixture may be a by-product of oilseed processing. For example, soy material may be processed with a solvent to remove oil and immersed in a basic solution to at least partially deplete the available protein. Fatty material may be added to the remaining at least partially defatted and protein-depleted soy hulls and/or soy cotyledons suspended in an aqueous solution. The fatty material may be added as part of an emulsion and mixed with the fiber mixture, or the fatty material may be added directly to the fiber mixture. Desirably, the fatty material has a temperature of at least about 120° F., and more preferably at least about 150° F. The fiber mixture may include other reagents, such as an emulsifying agent, to facilitate the formation of a high fat/fiber composition. The fiber mixture may be heated to a temperature of at least about 120° F., and more preferably at least about 150° F., and this may be heated before, during, or after addition of the fatty material. The fat/fiber mixture may be dried to provide the high fat/fiber composition, which desirably include at least about 30 wt. % fiber material and at least about 30 wt. % fatty material. In particular embodiments, it may be desirable to use fatty material having at least about 25 wt. % polyunsaturated fatty material.

The present high fat/fiber compositions can be used to produce animal feeds which have a higher than normal fat content. Desirably, the animal feed includes at least about 15 wt. % fatty material and at least 2 wt. % added plant fiber such as soy cotyledon fiber. In the preferred embodiment, the animal feed includes about 18 wt. % fatty material, and more desirably at least about 20 wt. %. In some embodiments, the fatty material includes an amount of polyunsaturated fatty material, resulting in an animal feed with at least about 1 wt. % polyunsaturated fatty material on a total weight basis, and more desirably at least about 2 wt. % polyunsaturated fatty material. In particular embodiments, the animal feed may have at least about 5 wt. % of plant fiber on a total weight basis. The plant fiber may include cotyledon fiber, hull fiber, bran fiber, processed cellulose and/or hemicellulose, and root vegetable fiber. The animal feed may be pelleted by either a pellet mill or an extruder. When pelleted, the animal feed pellet preferably has durability index (PDI) of at least 90%, and even more preferably 95%. Additionally, the pelleted animal feed may have a pellet breaking index of at least about 50%.

In one embodiment, an emulsion may be added to an animal feed premix formula including plant fiber material blended with the other feed ingredients. The plant fiber material desirably includes at least about 30 wt. % fiber, and more preferably includes at least about 50 wt. % fiber. The plant fiber material may include cotyledon fiber, but may also include other fiber material such as fiber material with about 50 to 70 wt. % insoluble non-starch polysaccharides and about 15 to 30 wt. % soluble non-starch polysaccharides, hull material, bran material, processed cellulose, and/or root vegetable material. Examples of these types of fiber materials include oat hulls, sunflower hulls, defatted, protein depleted soy cotyledon material, grain screenings, beet pulp, maltsprouts, defatted rice bran, rice hulls, corn hulls, and soy hulls.

Generally, the animal feed premix may be placed in a conditioner. The emulsion can then be added to the animal feed premix to provide an animal feed blend that can be mixed within the conditioner, for example by a ribbon blender or some other agitator capable of blending the animal feed premix and emulsion. The animal feed blend is desirably mixed and allowed to set for a sufficient time to permit the emulsion to be incorporated within the high fiber material, resulting in a high fat content animal feed having a lower oil release factor than animal feeds made by other methods. The emulsion may include fatty material and water (and optionally an emulsifying agent) and be formed by either dynamic mixing or static mixing as previously described. In the preferred embodiment, the amount of high fiber material added to the other feed ingredients can be about equal to the content of fatty material in the emulsion, although this ratio is not necessary. In some embodiments, the fatty material may include at least about 25 wt. % polyunsaturated fatty material.

Preferably, the emulsion has a temperature of at least about 120° F., although the emulsion may have a temperature of about 150° F. (circa 65° C.) to 190° F. (circa 92° C.) and, more commonly, about 170° F. (circa 76° C.) to 180° F. (circa 82° C.). The emulsion may be heated to this temperature after the fatty material and aqueous solution are combined, or at least one of the fatty material and aqueous solution may be heated prior to emulsification to achieve the desired temperatures. The emulsion may be sprayed into the conditioner at a controlled rate through the use of a flow meter and meter pump. This process may be conducted in batch or continuous processes depending on the manufacturing requirements and use of a dynamic or passive mixer.

In another embodiment, animal feeds can be formed by including the high fat/fiber composition, in either dry flowable form or wet form, to the animal feed ingredients to provide the animal feed blend. In forming such feeds, the animal feed blend typically includes about 2 to 15 wt. % of the present high fat/fiber composition and, more desirably, about 5 to 12 wt. % of the high fat/fiber composition.

The animal feed may be formed into a pellet for easy handling, storage, and consumption. The animal feed blend may be forced through an orifice either directly from the conditioner, or from a different hopper, and then divided into segments. Common methods may be employed including the use of an extruder or pelletizer. The animal feed blend may be divided by a rotating die or a knife that cuts the animal blend as it is forced through the orifice. The segments may then be dried to provide the animal feed pellets. The pelleted animal feed is commonly dried to a moisture content of no more than about 10 wt. % and, more preferably, no more than about 7 wt. % to enhance its storage properties. The pelleted animal feed generally exhibits enhanced physical properties in comparison to materials lacking the high fat/fiber composition or high fiber material with emulsion. Namely the pelleted animal feed of the present application has a higher pellet durability index (at least about 90%, and more preferably about 95%), high pellet breaking index (at least about 50%), and lower oil release factor than pelleted animal feed having a similar fatty material content made by other methods.

The following examples are presented to illustrate the present invention and to assist one of ordinary skill in making and using the same. The examples are not intended in any way to otherwise limit the scope of the invention.

### EXAMPLES

### Example 1

Water (150 lbs) was heated to 150° F. (circa 65° C.) and 68 grams of sodium alginate was added to the hot water and dissolved. The sodium alginate was chosen as the emulsifying agent and as a binder. The alginate solution was then heated to 180° F. (circa 80° C.). At this point 150 lbs of poultry fat was added to the hot alginate solution and mixed vigorously in order to form a good emulsion. After mixing for 15 minutes, 150 lbs of soy fiber (POLYSOY soy fiber; available from Protein Technologies International, St. Louis, Mo.) in the form of less than 1.5 mm particles was added to the emulsion and blended together quickly. The resulting mash was then fed into a conditioner and extruded into a pellet under standard conditions with no additional heat added. The resulting pellets were dried at 250° F. (circa 120° C.) for 30 minutes (to circa 6 wt. % moisture content). The dried material was reground through a hammer mill to produce particles which passed through a #5 screen (smaller than about 2 mm), with most of the particles having a particle size of no more than about 1 mm. The final flowable product (“FP”) was 235 lbs of dry, free flowing powder having a non-oily appearance and a fat content of 47.8 wt. % (total weight basis).

### Example 2

An experiment was conducted to determine the ability of soy fiber as a dry ingredient to a feed formulation to enhance the ability of the formulation to contain high levels of fat. The soy fiber was added as a dry ingredient with the rest of the feed ingredients and an emulsion including fat and water was added to the dry feed mix at the conditioner. This is where the dry feed ingredients are mixed with water and cooked prior to extrusion or pelleting.

Equine feed formulas prepared using dry feed ingredients alone typically contain a maximum fat content of 17.5% fat. A standard 17.5% fat equine feed formula was used as a base formulation in this experiment and formulated with additional fat and fiber using one embodiment of the present method. Soy cotyledon fiber (400 lbs; POLYSOY soy cotyledon fiber) was added to 7200 lbs of the dry ingredients for a standard equine feed formula having a 17.5% fat content. The resulting dry feed mix was formulated into a pellet feed after being combined with 800 lbs. of a soybean oil/water emulsion in the conditioner of the pelletizer apparatus.

A mixing vessel equipped with a heated steam jacket and a feed pump located at the outlet, was attached to the conditioner of one of the extruders. Water (400 lbs) was heated to 150° F. (circa 65° C.) in the vessel and 182 grams of sodium alginate was dissolved in the hot water. Soybean oil (400 lbs) was then added to the hot alginate solution and agitated vigorously.

A pump was set to feed 17 lbs per minute of the hot emulsion into the conditioner of an extruder. This rate delivered an additional 5 wt. % of soybean oil to the mixture of the blend of soy fiber with the standard 17.5% fat equine feed formula, which was added to the conditioner at a rate of 162 lbs per minute. The mixture of the emulsion and the fiber enhanced feed formula meal were conditioned with dry steam to 180° F. (circa 80° C.) in the condition chamber. The rest of the process involved the standard procedure for producing an extruded pellet under standard conditions with no additional heat added. The resulting feed pellets had a fat content of 23 wt. % (versus a maximum of 17.5 wt. % in standard equine feed formulations). The appearance and integrity of the pellets from a visual standpoint was very good. A schematic of the process described in example 2 is shown in FIG. 2.

### Example 3

Variations of a simplified swine grower diet for pigs between 25 and 65 pounds were formulated containing varying levels of fat in the form of either poultry fat or the FP produced according to Example 1. A conventional corn, soybean-meal, and wheat midds containing basal diet without drugs, vitamins, and trace minerals was formulated with the added poultry fat or FP. The composition of the test diets is reported in Table 3.

Experimental treatments were chosen to compare the effect of fat addition at commercial levels using either straight poultry fat or poultry fat in FP on pellet quality. An intermediate and higher fat inclusion rate via FP were also included. A pellet quality reference diet without added fat was also be tested.

TABLE 3
Experimental Swine Grower Diets

| | | 3b | 3c | 3d | 3e | 3f | 3g |
|---|---|---|---|---|---|---|---|
| | 3a | Added | Added | Added FP | Added FP | Added FP | Added FP |
| | Added | Poultry Fat | Poultry Fat | Fat | Fat | Fat | Fat |
| Ingredients | Fat | 2.50% | 5.00% | 5.00% | 7.50% | 10% | 15% |
| Corn, fine | 62.000 | 59.500 | 57.000 | 59.500 | 58.250 | 57.000 | 54.500 |
| grnd | | | | | | | |
| Wheat | 5.000 | 5.000 | 5.000 | 5.000 | 5.000 | 5.000 | 5.000 |
| Midds | | | | | | | |
| Hi Pro Soy | 30.000 | 30.000 | 30.000 | 27.500 | 26.250 | 25.000 | 22.500 |
| Meal | | | | | | | |
| Salt | 0.750 | 0.750 | 0.750 | 0.750 | 0.750 | 0.750 | 0.750 |
| Calcium | 1.000 | 1.000 | 1.000 | 1.000 | 1.000 | 1.000 | 1.000 |
| Carb | | | | | | | |
| Bio-Phos | 1.250 | 1.250 | 1.250 | 1.250 | 1.250 | 1.250 | 1.250 |
| Poultry Fat | | 2.500 | 5.000 | | | | |
| FP | | | | 5.000 | 7.500 | 10.000 | 15.000 |

Diets were manufactured under the standard production settings. Mixed meal was fed into the conditioning chamber of the extruder and conditioned with dry steam to 180° F. (82° C.). Pellet quality measurements were taken on cold pellets and included pellet PDI, pellet breaking index, and the density of the cold pellet. The pellet PDI and pellet breaking index results are shown in Tables 4 and 5 below, respectively. The PDI was determined using the procedure adapted by McEllhiney, R. R. as previously described. The pellet breaking index was also determined by the process previously described.

TABLE 4
Pellet PDI

| | | Mean | StDev | | | |
|---|---|---|---|---|---|---|
| Diet | Description | G | g | c.v. | PDI | StDev |
| 3a | Neg Ctrl | 480.3 | 0.58 | 0.12% | 96% | 0.1% |
| 3b | 2.5% PF | 456.6 | 4.33 | 0.95% | 91% | 0.9% |
| 3c | 5.0% PF | 444.7 | 7.51 | 1.69% | 89% | 1.5% |
| 3d | 5.0% FP | 481.3 | 5.77 | 1.20% | 96% | 1.2% |
| 3e | 7.5% FP | 469.7 | 5.51 | 1.17% | 94% | 1.1% |
| 3f | 10.0% FP | 474.3 | 5.86 | 1.24% | 95% | 1.2% |
| 3g | 15.0% FP | 402.7 | 3.06 | 0.76% | 81% | 0.6% |

TABLE 5
Pellet Breaking Index

| | | | | | Break- | | |
|---|---|---|---|---|---|---|---|
| | De- | | | | ing | | |
| | scrip- | | Out, | | Index | | |
| Diet | tion | In, g | g | % | % | StDev | c.v. |
| 3a | Neg | 50.03 | 32.79 | 65.5 | 67.2 | 1.68 | 2.50% |
| | Ctrl | | | | | | |
| | | 50.02 | 33.57 | 67.1 | | | |
| | | 50.02 | 34.46 | 68.9 | | | |
| 3b | 2.5% | 50.04 | 18.34 | 36.7 | 36.5 | 0.52 | 1.41% |
| | PF | | | | | | |
| | | 50.00 | 18.50 | 37.0 | | | |
| | | 50.05 | 18.01 | 36.0 | | | |
| 3c | 5.0% | 50.03 | 15.92 | 31.8 | 30.8 | 2.26 | 7.35% |
| | PF | | | | | | |
| | | 50.02 | 16.16 | 32.3 | | | |
| | | 50.02 | 14.09 | 28.2 | | | |
| 3d | 5.0% | 50.01 | 30.60 | 61.2 | 59.7 | 1.41 | 2.36% |
| | FP | | | | | | |
| | | 50.02 | 29.20 | 58.4 | | | |
| | | 50.00 | 29.80 | 59.6 | | | |
| 3e | 7.5% | 50.02 | 30.56 | 61.1 | 59.6 | 1.61 | 2.69% |
| | FP | | | | | | |
| | | 50.02 | 28.97 | 57.9 | | | |
| | | 50.05 | 29.99 | 59.9 | | | |
| 3f | 10.0% | 50.02 | 28.86 | 57.7 | 57.2 | 1.49 | 2.61% |
| | FP | | | | | | |
| | | 50.03 | 29.19 | 58.3 | | | |
| | | 50.02 | 27.76 | 55.5 | | | |
| 3g | 15.0% | 50.04 | 5.11 | 10.2 | 11.7 | 1.55 | 13.23% |
| | FP | | | | | | |
| | | 50.00 | 6.65 | 13.3 | | | |
| | | 50.03 | 5.79 | 11.6 | | | |

### Example 4

The following described process has the benefits of being a continuous process. Generally, the step of mixing the emulsion in a batch tank has been eliminated.

Referring to FIG. 3, equal parts of water and oil or fat are simultaneously fed together into a central line at a controlled rate (flow meters). The combined fat and water are emulsified using a static mixer from Controls and Meters, Minneapolis, Minn., which is also equipped with a steam jacket to heat the emulsion to about 150° F. No emulsifying agent is required. The emulsion continues to the conditioner and is sprayed and absorbed as it comes in contact with the POLYSOY soy cotyledon material that has been added to the feed formula in equal parts to the fat. Again, the whole process is continued in the conventional feed manufacturing method to provide pelleted feed.

### Example 5

High fat content feed was prepared by mixing rice bran, corn, flaxseed, calcium carbonate, vitamin E, and POLYSOY soy cotyledon material in a ribbon blender and grinding these ingredients through a hammer mill to produce an animal feed premix. The animal feed premix was transferred to a bin for feeding to an extruder conditioner at a controlled rate. A hot emulsion of soybean oil and water was added to the extruder conditioner via an emulsion flow meter to provide a mash. The rates of introduction of the animal feed premix and the hot emulsion were controlled to provide a mash which included one part by weight soybean oil for each part by weight POLYSOY soy cotyledon material in the animal feed premix. The mash was extruded into pellets. The wet pellets were transferred to a bed dryer and dried to a less than 10 wt. % water. The finished product included 58.65% rice bran, 20% corn, 10% flaxseed, 1% calcium carbonate, 0.35% vitamin E, 5% soybean oil and 5% POLYSOY soy cotyledon material, on a dry solids basis. This equine feed includes about 22% fatty material.

### Example 6

High fat content feed was prepared by mixing rice bran, corn, flaxseed, and POLYSOY soy cotyledon material in a ribbon blender and grinding these ingredients through a hammer mill to produce an animal feed premix. The animal feed premix was transferred to a bin for feeding to an extruder conditioner at a controlled rate. A hot emulsion of soybean oil and water was added to the extruder conditioner via an emulsion flow meter to provide a mash. The rates of introduction of the animal feed premix and the hot emulsion were controlled to provide a mash which included one part by weight soybean oil for each part by weight POLYSOY soy cotyledon material in the animal feed premix. The mash was extruded into pellets. The wet pellets were transferred to a bed dryer and dried to a less than 10 wt. % water. The finished product included 50 wt. % rice bran, 20 wt. % corn, 10 wt. % flaxseed, 10 wt. % soybean oil and 10 wt. % POLYSOY soy cotyledon material, on a dry solids basis. This feed includes about 20% fatty material.

### Example 7

Soybean meal is processed to isolate protein contained therein. Upon protein extraction, a high moisture soy cotyledon fiber remains. The high moisture soy cotyledon fiber obtained from such a process typically includes approximately 80 wt. % water. After drying the high moisture soy cotyledon fiber to approximately 50 wt. % water content, an equal portion of soapstock (e.g., aqueous emulsion of mixed phospholipids) or an oil in water emulsion to dried fiber can be heated to about 150° F. to 170° F. and added to the wet soy cotyledon fiber. Preferably, the wet soy cotyledon fiber is heated to about 150° F. prior to the introduction of the soapstock and/or oil emulsion. The fat-fiber mixture can be agitated through mixing and/or blending. The resulting wet high fiber/high fat product is then dried to under 10 wt. % water, and can be sold as is or used as a feed additive.

### Example 8

The flowability of a high fat/fiber compositions made with a hot emulsion was compared with the flowability of a high fat/fiber compositions made with a room temperature emulsion. Soy hull fiber was mixed with different emulsions having a temperature of 150° F. The resulting high fat/fiber compositions had the following fat levels: 0%, 10%, 30%, and 50%. Soy hull fiber was also mixed with different emulsions at room temperature, resulting in high fat/fiber compositions with the following fat levels: 0%, 10%, 30%, and 50%. The results are shown in Table 6, wherein the larger angle of repose indicates a less flowable material.

TABLE 6
Angle of Repose

| High Fat/Fiber Composition made | | High Fat/Fiber Composition made | |
|---|---|---|---|
| with Hot Emulsion (150 degrees F.) | | with Room Temp. Emulsion | |
| | Angle of Repose | | Angle of Repose |
| Fat Level | (degrees) | Fat Level | (degrees) |
| 0% | 30 | 0% | 30 |
| 10% | 32 | 10% | 28 |
| 30% | 30 | 30% | 34 |
| 50% | 31 | 50% | 40 |

### Example 9

The pellet durability index was determined on six different sample diets. Added to three sample diets were varying levels of flowable particulate material (FP) produced by the methods described herein. Added to three comparison diets were varying levels fat sprayed over the surface of the feed as is typically done in the animal feed industry. The diets were mixed and formed into pelleted animal feed. The resulting data in Table 7 supports that diets having added fatty material in the form of the flowable particulate material described herein have improved pellet durability than diets having added liquid fat not in an emulsion. Each of the sample diets are provided in Tables 8, 9, and 10.

TABLE 7
Feed With FP

| Sample Diet | % Added Fat | PDI (Avg of 3) |
|---|---|---|
| S012866A | 16% | 94.40% |
| S012863A | 10% | 93.20% |
| S012862A | 8% | 94.30% |

Feed with Sprayed Fat

| Sample Diet | % Fat | PDI (Avg of 3) |
|---|---|---|
| T000153 | 16% | 70.00% |
| T000152 | 10% | 82.60% |
| T000150 | 8% | 89.80% |

TABLE 8
Sample Diets S012862A and T000150

| Ingredient | Mixture (lbs) | Level (%) |
|---|---|---|
| Deproteinized whey | 20.625 | 20.625 |
| Corn, fine grnd | 15.000 | 15.000 |
| Hi Pro Soy Meal | 15.000 | 15.000 |
| Hi-Fat Rice Bran | 10.000 | 10.000 |
| Appetein | 9.539 | 9.539 |
| Fat | 8.000 | 8.000 |
| Select Menhaden | 6.000 | 6.000 |
| Soy Hulls | 5.000 | 5.000 |
| Poly Soy | 4.000 | 4.000 |
| Beet Pulp | 2.370 | 2.370 |
| Bio-Phos | 1.217 | 1.217 |
| Calcium Carb | 1.012 | 1.012 |
| Soy Pro Conc | 0.912 | 0.912 |
| Zn Oxide-72 | 0.350 | 0.350 |
| Salt | 0.260 | 0.260 |
| Storage Mate II (Dry) | 0.200 | 0.200 |
| ** Mecadox-10 | 0.125 | 0.125 |
| Cargill Swine Tm Pmx | 0.100 | 0.100 |
| Cu Sulfate | 0.091 | 0.091 |
| DL Methionine | 0.086 | 0.086 |
| * Se .06% | 0.050 | 0.050 |
| * Cargill Swine Start/Fin Vit Pm | 0.050 | 0.050 |
| Micro-Aid Pack | 0.013 | 0.013 |
| | 100.000 | 100.000 |

TABLE 9
Sample Diets S012863A and T000152

| Ingredient | Mixture (lbs) | Level (%) |
|---|---|---|
| Deproteinized whey | 20.625 | 20.625 |
| Hi Pro Soy Meal | 15.000 | 15.000 |
| Corn, fine grnd | 14.227 | 14.227 |
| Hi-Fat Rice Bran | 10.000 | 10.000 |
| Fat | 10.000 | 10.000 |
| Appetein | 9.569 | 9.569 |
| Select Menhaden | 6.000 | 6.000 |
| Soy Hulls | 5.000 | 5.000 |
| Poly Soy | 4.000 | 4.000 |
| Beet Pulp | 2.000 | 2.000 |
| Soy Pro Conc | 1.012 | 1.012 |
| Bio-Phos | 0.795 | 0.795 |
| Calcium Carb | 0.657 | 0.657 |
| Zn Oxide-72 | 0.350 | 0.350 |
| Storage Mate II (Dry) | 0.200 | 0.200 |
| ** Mecadox-10 | 0.125 | 0.125 |
| Cargill Swine Tm Pmx | 0.100 | 0.100 |
| Cu Sulfate | 0.091 | 0.091 |
| DL Methionine | 0.086 | 0.086 |
| Salt | 0.050 | 0.050 |
| * Se .06% | 0.050 | 0.050 |
| * Cargill Swine Start/Fin Vit Pm | 0.050 | 0.050 |
| Micro-Aid Pack | 0.013 | 0.013 |
| | 100.000 | 100.000 |

TABLE 10
Sample Diets S012866A and T000153

| Ingredient | Mixture (lbs) | Level (%) |
|---|---|---|
| Deproteinized whey | 20.625 | 20.625 |
| Fat | 16.000 | 16.000 |
| Hi Pro Soy Meal | 15.000 | 15.000 |
| Hi-Fat Rice Bran | 10.000 | 10.000 |
| Appetein | 9.995 | 9.995 |
| Corn, fine grnd | 7.531 | 7.531 |
| Select Menhaden | 6.000 | 6.000 |
| Soy Hulls | 5.000 | 5.000 |
| Poly Soy | 4.000 | 4.000 |
| Beet Pulp | 2.000 | 2.000 |
| Soy Pro Conc | 1.306 | 1.306 |
| Bio-Phos | 0.791 | 0.791 |
| Calcium Carb | 0.631 | 0.631 |
| Zn Oxide-72 | 0.350 | 0.350 |
| Storage Mate II (Dry) | 0.200 | 0.200 |
| ** Mecadox-10 | 0.125 | 0.125 |
| Cargill Swine Tm Pmx | 0.100 | 0.100 |
| DL Methionine | 0.092 | 0.092 |
| Cu Sulfate | 0.091 | 0.091 |
| Salt | 0.050 | 0.050 |
| * Se .06% | 0.050 | 0.050 |
| * Cargill Swine Start/Fin Vit Pm | 0.050 | 0.050 |
| Micro-Aid Pack | 0.013 | 0.013 |
| | 100.000 | 100.000 |

What is claimed is:

1. A flowable high fat/fiber material comprising:
at least about 30 wt. % soy cotyledon fiber, oat hull fiber, sunflower hull fiber, beet pulp, or a combination thereof; and
at least about 20 wt. % fatty material.

2. The material of claim 1, wherein the fatty material is derived from an animal source, a plant source or a combination thereof.

3. The material of claim 2, wherein the fatty material derived from the plant source includes one of soybean oil, sunflower oil, palm oil, safflower oil, flaxseed oil and mixtures thereof.

4. The material of claim 2, wherein the fatty material derived from the animal source includes one of tallow, poultry fat, fish oil, beef fat, pork fat and mixtures thereof.

5. The material of claim 1, wherein the high fat/fiber material includes at least about 20 wt. % fat.

6. The material of claim 1, wherein the high fat/fiber material includes at least about 30 wt. % fatty material.

7. The material of claim 1, wherein at least about 25 wt. % of the fatty material is polyunsaturated fatty material.

8. The material of claim 1, wherein the high fat/fiber material has a water content of no more than about 10 wt. % on a total composition basis.

9. The material of claim 1, wherein the high fat/fiber material includes no more than about 10 wt. % proteinaceous material.

10. The material of claim 1, wherein the high fat/fiber material includes fish solubles.

11. The material of claim 1, wherein the high fat/fiber material includes an emulsifying agent.

12. The material of claim 1, wherein the high fat/fiber material includes at least about 30 wt. % fat and at least about 40 wt % soy cotyledon fiber.

13. A flowable particulate high fat/fiber material comprising:
at least about 30 wt. % fiber material derived from oilseed material; and
at least about 30 wt. % fatty material;
wherein the fiber material includes about 50 to 70 wt. % insoluble non-starch polysaccharides and about 15 to 30 wt. % soluble non-starch polysaccharides.

14. The material of claim 13, wherein the high fat/fiber material includes no more than about 10 wt. % proteinaceous material.

15. The material of claim 13, wherein the fiber material includes at least partially defatted and protein-depleted soy cotyledon material.

16. The material of claim 13, wherein the fiber material includes at least about 75 wt. % total fiber, no more than about 10 wt. % proteinaceous material, and no more than about 2 wt. % fat.

17. The material of claim 13, wherein the high fat/fiber material includes at least about 40 wt. % fiber material derived from at least partially defatted and protein-depleted soy cotyledons.

18. The material of claim 13, wherein the fiber material includes hull fiber.

19. A flowable particulate material comprising:
at least about 30 wt. % fatty material;
at least about 30 wt. % fiber material; and
no more than about 10 wt. % protein;
wherein the fiber material includes hull fiber, cotyledon fiber, bran fiber, vegetable root fiber or a combination thereof.

20. The flowable particulate material of claim 19, wherein the flowable particulate material includes at least about 40 wt. % fiber material.

21. The flowable particulate material of claim 19, wherein the flowable particulate material includes at least about 50 wt. % fatty material and at least about 45 wt. % fiber material.

22. The flowable particulate material of claim 19, wherein the cotyledon fiber includes soy cotyledon fiber.

23. The flowable particulate material of claim 19, wherein the hull fiber includes oat hull fiber, sunflower hull fiber, soybean hull fiber, rice hull fiber or a combination thereof.

24. The flowable particulate material of claim 19, wherein the flowable particulate material has an angle of repose of no more than 35 degrees.

25. The flowable particulate material of claim 19, wherein the fiber material includes oat hulls, sunflower hulls, defatted, protein depleted soy cotyledon material, beet pulp, or a combination thereof.

26. The flowable particulate material of claim 19, wherein the fatty material includes fatty material derived from fish.

27. The flowable particulate material of claim 19, wherein the fiber material includes about 50 to 70 wt. % insoluble non-starch polysaccharides and about 15 to 30 wt. % soluble non-starch polysaccharides.

28. An animal feed including the flowable particulate material of claim 19.

29. An animal feed comprising:
at least about 18 wt. % fatty material;
at least about 5 wt. % fiber including oat hull fiber, sunflower hull fiber, beet pulp, soy cotyledon fiber, or a combination thereof.

30. The animal feed of claim 29, wherein the animal feed includes at least about 20 wt. % fat.

31. The animal feed of claim 29, wherein the animal feed has a pellet breaking index of at least 50%.

32. The animal feed of claim 29, wherein the animal feed is in the form of pellets having a pellet durability index of at least 90%.

33. The animal feed of claim 29, wherein the animal feed has at least about 20 wt. % fatty material.

34. The animal feed of claim 29, further comprising maltsprouts, soy hull fiber, rice hull fiber, rice bran fiber, or a combination thereof.

35. A method of making a high fat/fiber material comprising:
forming an emulsion including fatty material and water; and
contacting the emulsion with high plant fiber material to provide a mash.

36. The method of claim 35, wherein the emulsion further includes an emulsifying agent.

37. The method of claim 36, wherein the emulsifying agent includes a non-ionic surfactant.

38. The method of claim 36, wherein the emulsifying agent includes lecithin, alginate, carrageenan, glycol, a fatty acid salt, or a combination thereof.

39. The method of claim 35, wherein the ratio of emulsion to high fiber material is approximately two to one.

40. The method of claim 35, wherein the emulsion has a temperature of at least about 120° F.

41. The method of claim 35, further comprising heating the mash.

42. The method of claim 35, further comprising drying the mash to provide a high fat/fiber material with a water content of no more than about 10 wt. % on a total composition basis.

43. The method of claim 42, wherein the dried high fat/fiber material is comminuted to provide a flowable high fiber/high fat material.

44. The method of claim 35, wherein forming the emulsion is facilitated by a dynamic mixer.

45. The method of claim 35, wherein forming the emulsion is facilitated by a passive mixer.

46. The method of claim 35, further comprising adding the mash to an animal feed premix to provide an animal feed blend.

47. The method of claim 46, further comprising:
forcing the animal feed blend through an orifice;
dividing the animal feed blend into segments; and
drying the segments to provide a pelleted animal feed having a moisture content of no more than about 10 wt. % on a total composition basis.

48. A method of making an animal feed comprising:
providing an animal feed premix which includes at least about 5 wt. % plant fiber; and
adding an emulsion to the animal feed premix to provide an animal feed blend;
wherein the emulsion includes water and fatty material.

49. The method of claim 48, wherein the fiber includes soy cotyledon fiber.

50. The method of claim 48, wherein the fiber includes about 50 to 70 wt. % insoluble non-starch polysaccharides and about 15 to 30 wt. % soluble non-starch polysaccharides.

51. The method of claim 48, wherein the fiber includes hull fiber, cotyledon fiber, bran fiber, root vegetable fiber, or a combination thereof.

52. The method of claim 48, further comprising forming the animal feed blend into pellets having a pellet breaking index of at least 50%.

53. The method of claim 48, wherein the emulsion is added to the animal feed premix at a temperature of at least about 120° F.

54. The method of claim 48, wherein the animal feed blend includes at least about 2 wt. % defatted, protein depleted soy cotyledon material and at least 18 wt. % fatty material.

55. A method of making a high fat/fiber composition comprising:
providing a wet fiber mixture including high fiber material and at least about 30 wt. % water;
adding fatty material to the wet fiber mixture to provide a fat/fiber mixture; and
removing water from the fat/fiber mixture to provide a high fat/fiber composition including at least about 30 wt. % fiber, at least about 30 wt. % fatty material, and no more than about 10 wt. % water, all calculated on a total composition basis.

56. The method of claim 55, wherein the fiber mixture includes at least about 30 wt. % high fiber material.

57. The method of claim 55, wherein the fiber mixture includes at least about 50 wt. % water.

58. The method of claim 55, wherein adding the fatty material comprises adding an aqueous emulsion of the fatty material to the fiber mixture.

59. The method of claim 55, wherein at least about 25 wt. % of the fatty material is polyunsaturated fatty material.

60. The method of claim 55, wherein the fiber mixture includes cotyledon fiber, hull fiber, bran fiber, vegetable root fiber or a combination thereof.

61. The method of claim 55, wherein the fiber mixture includes soy cotyledon fiber.

62. The method of claim 58, wherein the emulsion has a temperature of at least about 120° F.

63. The method of claim 58, wherein the emulsion includes an emulsifying agent.

64. An animal feed in pelletized form comprising at least about 20 wt. % fatty material; at least about 5 wt. % plant fiber material; and having a pellet breaking index of at least about 50%.

65. The animal feed of claim 64, wherein the fiber material includes cotyledon fiber, hull fiber, root vegetable fiber, bran fiber or a combination thereof.

66. The animal feed of claim 64, wherein the feed has pellet durability index of at least about 90%.

67. An animal feed made by a process comprising: contacting an aqueous emulsion including fatty material to an animal feed premix which includes at least about 5 wt. % plant fiber to provide an animal feed blend; and converting the animal feed blend to pellets; wherein the animal feed blend includes at least about 5 wt. % added fatty material.

68. The animal feed of claim 67, wherein the emulsion is contacted to the animal feed premix at a temperature of at least about 120° F.

69. The animal feed of claim 67, wherein the plant fiber includes oat hull fiber, sunflower hull fiber, soy cotyledon fiber, beet pulp, maltsprouts, soy hulls, rice bran, rice hulls, or a combination thereof.

70. A pelleted animal feed comprising at least about 5 wt. % plant fiber; and at least about 2 wt. % added fatty material; wherein the feed has an oil release factor of no more than 40% and a pellet durability index of at least 90%.
